(19) United States
(12) Patent Application Publication
(10) Pub. No.: US 2021/0243288 A1
(43) Pub. Date: Aug. 5, 2021

(54) CAMERA MODULE AND PORTABLE ELECTRONIC DEVICE INCLUDING THE SAME

(71) Applicant: Samsung Electro-Mechanics Co., Ltd., Suwon-si (KR)

(72) Inventors: Jae Woo JUN, Suwon-si (KR); Chul CHOI, Suwon-si (KR)

(73) Assignee: Samsung Electro-Mechanics Co., Ltd., Suwon-si (KR)

(21) Appl. No.: 17/070,171

(22) Filed: Oct. 14, 2020

(30) Foreign Application Priority Data
Feb. 3, 2020 (KR) 10-2020-0012717

(51) Int. Cl. H04M 1/02; G06F 1/16; G03B 5/02

(52) U.S. Cl. CPC H04M 1/0264; G03B 2217/002; G03B 5/02; G06F 1/1686

(57) ABSTRACT

A camera module is provided. The camera module includes a base plate and a plurality of cameras provided on the base plate, wherein one of the plurality of cameras is configured to be moved by a driver, and wherein the other cameras of the plurality of cameras are configured to move while being interlocked with the one of the plurality of cameras.

### CROSS-REFERENCE TO RELATED APPLICATION(S)

This application claims the benefit under 35 USC § 119(a) of Korean Patent Application No. 10-2020-0012717, filed on Feb. 3, 2020, in the Korean Intellectual Property Office, the entire disclosure of which is incorporated herein by reference for all purposes.

### BACKGROUND

### 1. Field

The following description relates to a camera module and a portable electronic device including the same.

### 2. Description of Related Art

Cameras have recently been implemented in portable electronic devices such as smartphones, and also in tablet personal computers (PCs), laptops, and the like.

Furthermore, to obtain various effects or operations that may be difficult to implement with a single camera, a structure in which a plurality of cameras, rather than a single camera, are disposed in a portable electronic device has also been implemented.

However, since the positions of a plurality of cameras are generally fixed, there are limitations in implementing various effects even when a plurality of cameras are arranged in a portable electronic device.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a base plate; and a plurality of cameras provided on the base plate, wherein one of the plurality of cameras is configured to be moved by a driver, and wherein the other cameras of the plurality of cameras are configured to move while being interlocked with the one of the plurality of cameras.

A distance between the other cameras may be configured to decrease or increase when the one of the cameras moves.

A direction in which the one of the cameras moves may be perpendicular to a direction in which other cameras move.

A plurality of guide holes having lengths in moving directions of the plurality of cameras, respectively, may be provided in the base plate, each of the plurality of cameras may include a protrusion disposed in a corresponding guide hole, and the plurality of cameras may be configured to move along the plurality of guide holes.

The one of the cameras may be connected to the other cameras by a link member.

The driver may include a motor and a first gear connected to the motor, and the one of the cameras may include a second gear connected to the first gear.

The plurality of cameras may include a first camera, a second camera, and a third camera, the first camera may be disposed between the second camera and the third camera, and the second camera and the third camera may be configured to move while being interlocked with the first camera.

The first camera and the second camera may be connected to each other by a first link member, and the first camera and the third camera may be connected to each other by a second link member.

The first camera, the second camera, and the third camera may be configured to move from a position in which centers of the first camera, the second camera, and the third camera are linearly disposed, to a position in which the centers of the first camera, the second camera, and the third camera form a triangular shape.

The first camera, the second camera, and the third camera may be configured to have different fields of view.

In a general aspect, a portable electronic device includes a case and a cover coupled to each other, and configured to form an internal space; and a camera module disposed in the internal space, wherein the camera module comprises a base plate; at least three cameras provided on the base plate; a driver configured to move one of the at least three cameras in a first direction; and a link member configured to connect the one of the cameras to each of the other cameras, wherein the other cameras may be configured to move in a second direction perpendicular to the first direction while being interlocked with the one of the cameras.

The at least three cameras may include a first camera, a second camera, and a third camera, and the second camera and the third camera may be configured to move closer or farther from each other when the first camera is moved by the driver.

The portable electronic device may further include a cover plate mounted on the cover, the cover plate including a first incident hole which has a length formed in the first direction, a second incident hole which has a length formed in the second direction, and a third incident hole which has a length formed in the second direction, wherein an infrared cut filter is mounted on one of a first side and a second side of the first incident hole, and an infrared pass filter is mounted on the other of the first side and the second side of the first incident hole.

The portable electronic device may further include a cover plate mounted on the cover, the cover plate including a first incident hole which has a length formed in the first direction, a second incident hole which has a length formed in the second direction, and a third incident hole which has a length formed in the second direction, wherein diameters of a first side and a second side of each of the first incident hole, the second incident hole, and the third incident hole are configured to be different from each other.

In a general aspect, a portable electronic device includes a case and a cover coupled to each other, and configured to form an internal space; and a camera module disposed in the internal space; wherein the camera module comprises a base plate a plurality of cameras provided on the base plate; a driver configured to selectively move the plurality of cameras in different respective directions; and a link member configured to connect the plurality of cameras based on a selection of the driver; wherein the plurality of cameras include a first camera, configured to move in a first direction; a second camera, configured to move in a second direction, perpendicular to the first direction; and a third camera, configured to move in a third direction, perpendicular to the first direction, wherein the second camera and the third camera are configured to move while being interlocked with the first camera.

The first camera, the second camera, and the third camera may be configured to have different fields of view.

A linear distance between the second camera and the third camera may increase or decrease based on a movement of the first camera.

The first camera may be connected to the second camera by a first link, and the first camera may be connected to the third camera by a second link.

Other features and aspects will be apparent from the following detailed description, the drawings, and the claims.

### BRIEF DESCRIPTION OF DRAWINGS

FIG. 1 is an exploded perspective view illustrating an example portable electronic device, in accordance with one or more embodiments;

FIG. 2 is a perspective view illustrating an example first camera, an example second camera, and an example third camera, in accordance with one or more embodiments;

FIG. 3 is a bottom perspective view illustrating an example first camera, an example second camera, and an example third camera, in accordance with one or more embodiments;

FIG. 4 is an exploded perspective view illustrating an example first camera, an example second camera, an example third camera, and an example base plate, in accordance with one or more embodiments;

FIGS. 5A to 5E are bottom views illustrating processes in which example first to third cameras are coupled to a base plate in order, in accordance with one or more embodiments;

FIGS. 6A to 6C are plan views illustrating moving of example first to third cameras, in accordance with one or more embodiments;

FIGS. 7A to 7C are bottom views illustrating moving of example first to third cameras, in accordance with one or more embodiments; and

FIGS. 8 to 10 are views illustrating examples of various imaging methods of an example camera module, in accordance with one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains after an understanding of the disclosure of this application. Terms, such as those defined in commonly used dictionaries, are to be interpreted as having a meaning that is consistent with their meaning in the context of the relevant art and the disclosure of the present application, and are not to be interpreted in an idealized or overly formal sense unless expressly so defined herein.

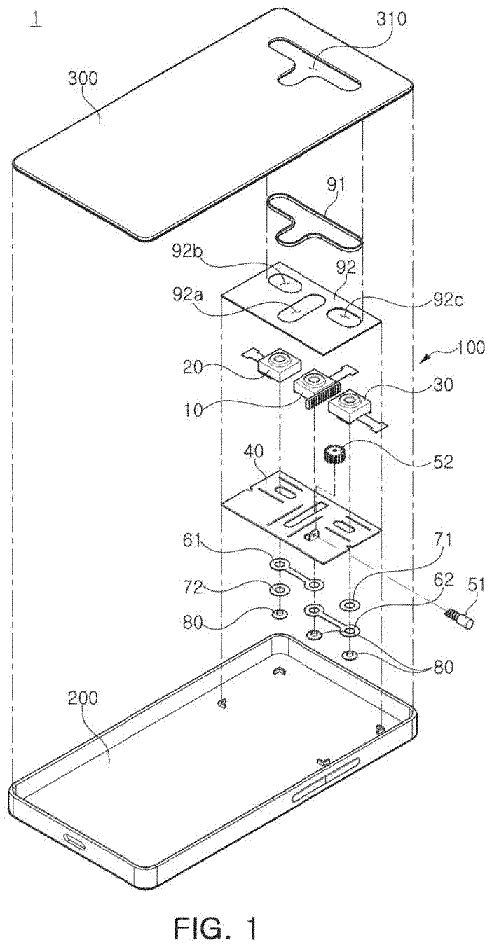

FIG. 1 is an exploded perspective view illustrating an example portable electronic device, in accordance with one or more embodiments.

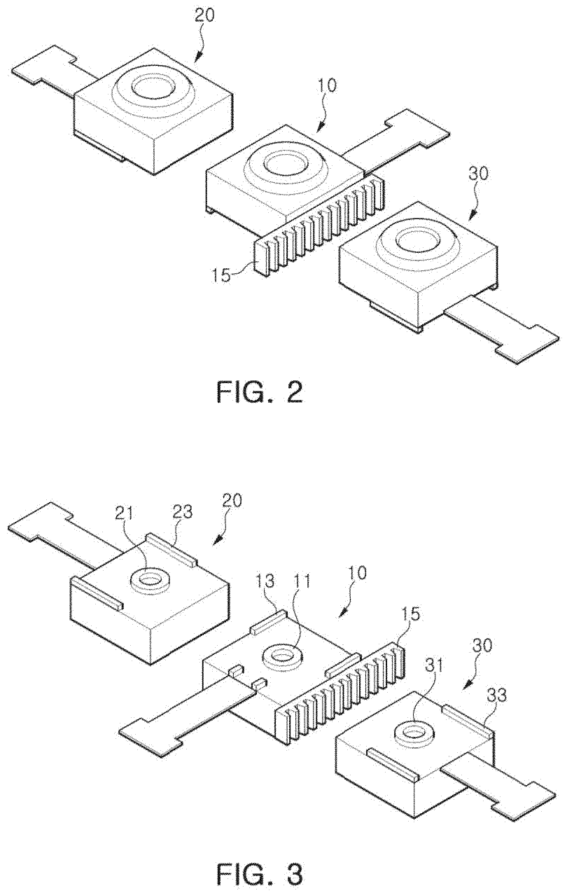

FIG. 2 is a perspective view illustrating an example first camera, an example second camera, and an example third camera, in accordance with one or more embodiments. FIG. 3 is a bottom perspective view illustrating an example first camera, an example second camera, and an example third camera, in accordance with one or more embodiments.

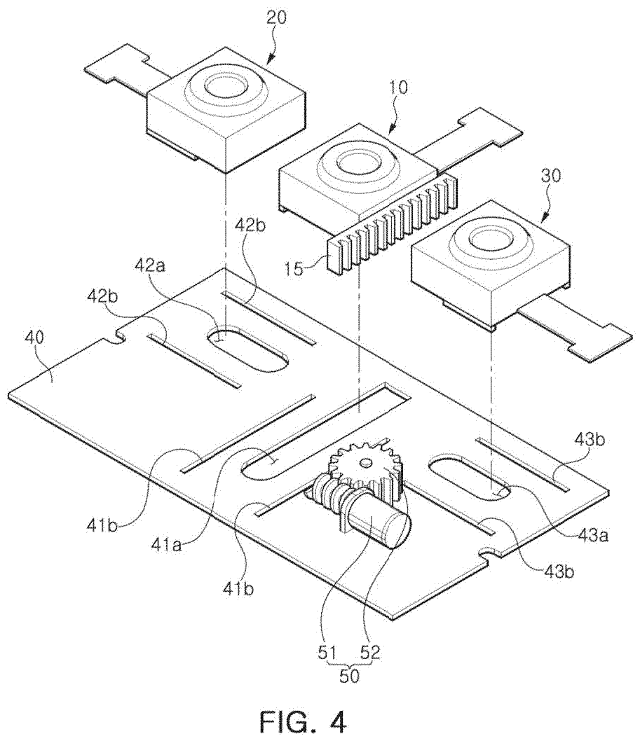

FIG. 4 is an exploded perspective view illustrating an example first camera, an example second camera, an example third camera, and an example base plate, in accordance with one or more embodiments.

A portable electronic device 1, in accordance with an example, may be implemented by a mobile communications terminal device, such as, as non-limiting examples, a smartphone, a tablet PC, or the like.

Referring to FIGS. 1 to 4, the example portable electronic device 1 may include a case 200, a cover 300, and a camera module 100.

The case 200 and the cover 300 may form an exterior of the portable electronic device 1, and the camera module 100 may be disposed in an internal space of the portable electronic device 1 formed by the case 200 and the cover 300.

The camera module 100 may include a plurality of cameras, and the plurality of cameras may be configured such that relative positions of the cameras may change.

As an example, the camera module 100 may include a first camera 10, a second camera 20, and a third camera 30, each configured to image an object individually.

In an example, the camera module 100 may include three cameras, but is the examples are not limited thereto. The camera module may include at least three cameras or less than three.

The camera module 100 may include the first camera 10, the second camera 20, the third camera 30, a base plate 40, and a driver 50 (51/52).

The first camera 10, the second camera 20, and the third camera 30 may be moveably mounted on one surface of the base plate 40.

The first camera 10 may be disposed between the second camera 20 and the third camera 30. The first camera 10 may be movable based on an operation by the driver 50, and the second camera 20 and the third camera 30 may be provided to move while being interlocked with the first camera 10.

In an example, a moving direction of the first camera 10 may be perpendicular to a moving direction of the second camera 20 and a moving direction of the third camera 30.

As an example, the first camera 10 may move in a first direction, and the second camera 20 and the third camera 30 may move in a second direction. The first direction and the second direction may be perpendicular to each other.

The second camera 20 and the third camera 30 may respectively move in an inward direction to be close to each other, or may respectively move in an outward direction to be spaced apart from each other as the first camera 10 moves.

The base plate 40 may include a plurality of guide holes penetrating the base plate 40 (see FIG. 4). As an example, the base plate 40 may include first guide holes 41a second guide holes 42a, and third guide holes 43a.

Each of the respective first to third guide holes 41a 42a, and 43a may have a shape having a length in a moving direction of a corresponding camera. As an example, the first guide holes 41a may be elongated in the first direction, and the respective second and third guide holes 42a and 43a may be elongated in the second direction, perpendicular to the first direction.

Each of the first to third cameras 10, 20, and 30 may have a protrusion (see FIG. 3). For example, the first camera 10 may include a first protrusion 11 protruding from a bottom surface of the first camera 10, the second camera 20 may include a second protrusion 21 protruding from a bottom surface of the second camera 20, and the third camera 30 may include a third protrusion 31 protruding from a bottom surface of the third camera 30.

The first protrusion 11 may be disposed in the first guide hole 41a the second protrusion 21 may be disposed in the second guide hole 42a, and the third protrusion 31 may be disposed in the third guide hole 43a.

A length of each of the first to third protrusions 11, 21, and 31 may be greater than a thickness of the base plate 40. Accordingly, each of the protrusions 11, 21, and 31 may be disposed to protrude to an external side of the base plate 40.

The base plate 40 may further include a plurality of guide rails. For example, the base plate 40 may include a first guide rail 41b, a second guide rail 42b, and a third guide rail 43b.

The first guide rail 41b may be disposed on both sides of the first guide hole 41a the second guide rail 42b may be disposed on both sides of the second guide hole 42a, and the third guide rail 43b may be disposed on both sides of the third guide hole 43a.

The first guide rails 41b may be elongated in the first direction, and the second and third guide rails 42b and 43b may be elongated in the second direction, perpendicular to the first direction.

Each of the first to third cameras 10, 20, and 30 may include guide projections (see FIG. 3). For example, the first camera 10 may include first guide projections 13 that are configured to be inserted into the first guide rails 41b, the second camera 20 may include second guide projections 23 that are configured to be inserted into the second guide rails 42b, and the third camera 30 may include third guide projections 33 that are configured to be inserted into the third guide rails 43b.

The first camera 10 may move in the first direction along the first guide hole 41a and the first guide rails 41b.

The second camera 20 may move in the second direction, perpendicular to the first direction, along the second guide hole 42a and the second guide rails 42b.

The third camera 30 may move in the second direction, perpendicular to the first direction, along the third guide hole 43a and the third guide rails 43b.

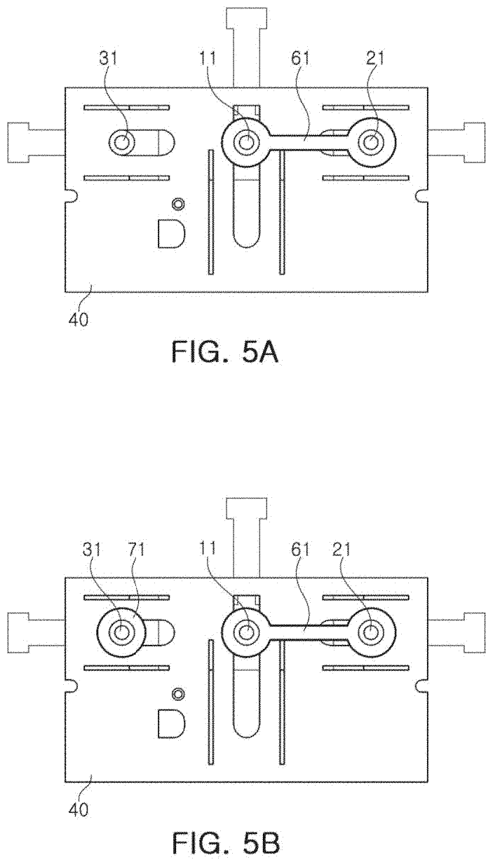

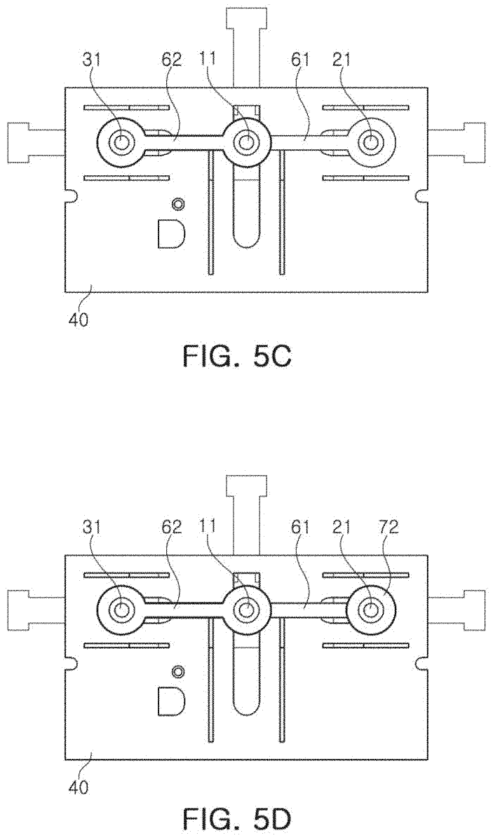

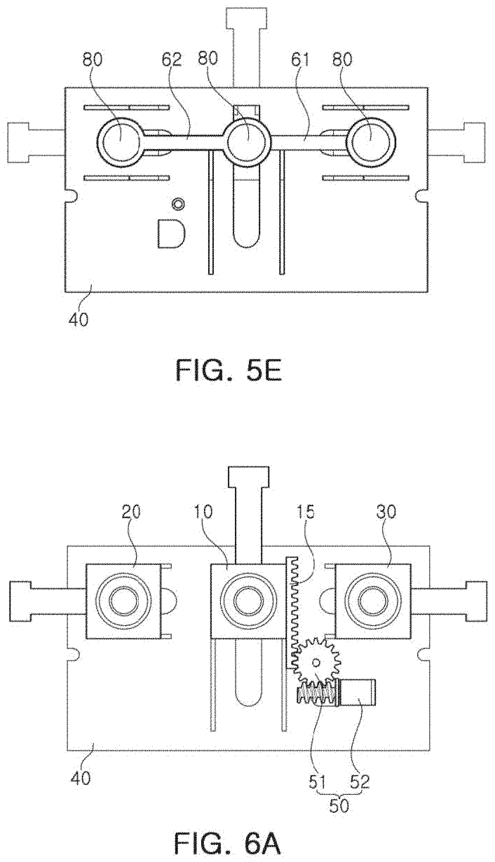

FIGS. 5A to 5H are bottom views illustrating example processes in which first to third cameras are coupled to a base plate in order, in accordance with one or more embodiments.

In an example, the first to third cameras 10, 20, and 30 may be directly or indirectly connected to each other by a link member.

The first to third cameras 10, 20, and 30 may be mounted on one surface of the base plate 40, and a link member may be mounted on the other side of the base plate 40. The link member may include a first link member 61 and a second link member 62.

Referring to FIG. 5A, the first camera 10 may be connected to the second camera 20 by the first link member 61. An insertion hole may be provided on each of both ends of the first link member 61. The insertion hole may be coupled to the first protrusion 11 of the first camera 10 and the second protrusion 21 of the second camera 20. In a non-limiting example, the insertion hole of each of the first protrusion 11 of the first camera 10, the second protrusion 21 of the second camera 20, and the first link member 61 may have a circular shape.

Referring to FIG. 5B, a first washer 71 may be coupled to the second surface of the base plate 40 in a position in which the third camera 30 is mounted. Also, the first washer 71 may be coupled to the third protrusion 31 of the third camera 30. In an example, the thickness of the first washer 71 may correspond to a thickness of the first link member 61.

Referring to FIG. 5C, the first camera 10 may be connected to the third camera 30 by the second link member 62. An insertion hole may be provided in each of both ends of the second link member 62. The insertion hole may be coupled to the first protrusion 11 of the first camera 10 and the third protrusion 31 of the third camera 30. In an example, each of the insertion holes of the first protrusion 11 of the first camera 10, the third protrusion 31 of the third camera 30, and the second link member 62 may have a circular shape.

Referring to FIG. 5D, a second washer 72 may be coupled to the first link member 61. Also, the second washer 72 may be coupled to the second protrusion 21 of the second camera 20. In an example, the thickness of the second washer 72 may correspond to a thickness of the second link member 62.

Referring to FIG. 5E, a cap 80 may be coupled to an end of each of the respective protrusions 11, 21, and 31 to prevent the first link member 61 and the second link member 62 from being detached.

The first link member 61, the second link member 62, and the cap 80 may be coupled to the first protrusion 11 in order, the first link member 61, the second washer 72, and the cap 80 may be coupled to the second protrusion 21 in order, and the first washer 71, the second link member 62, and the cap 80 may be coupled to the third protrusion 31 in order.

As the first camera 10 is connected to the second camera 20 by the first link member 61, and the first camera 10 is connected to the third camera 30 by the second link member 62, the second camera 20 and the third camera 30 may move while being interlocked with the first camera 10.

In other words, as the first camera 10 moves in the first direction, the second camera 20 and the third camera 30 may move in the second direction, perpendicular to the first direction.

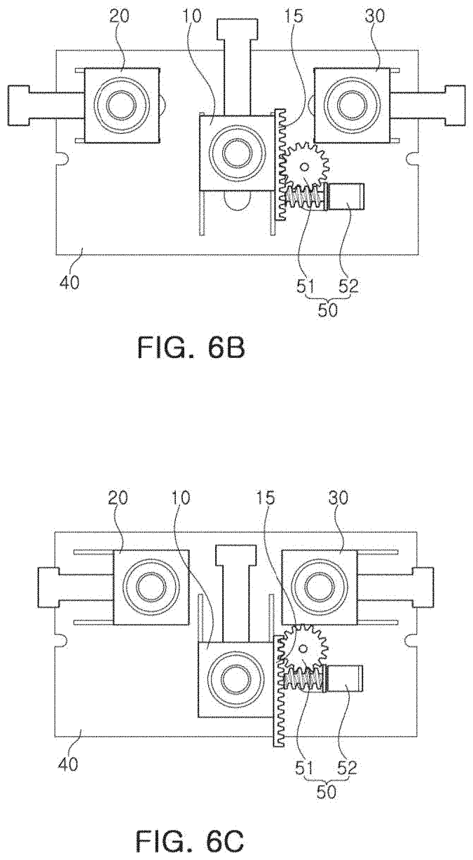

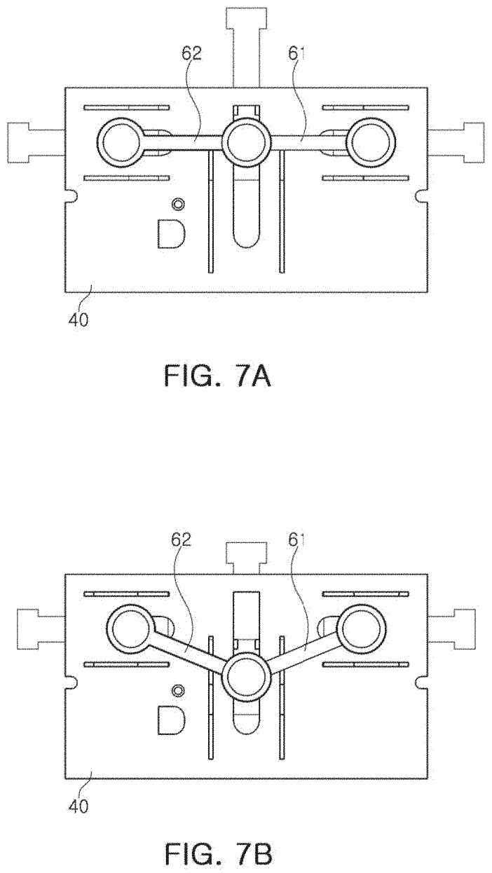

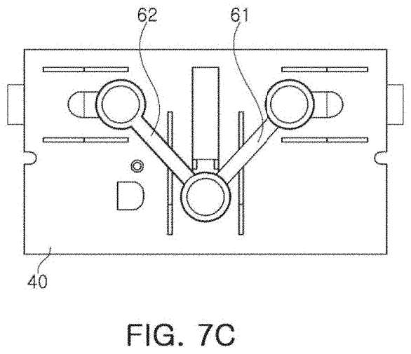

FIGS. 6A to 6C are plan views illustrating a moving operation when first to third cameras are moved, in accordance with one or more embodiments. FIGS. 7A to 7C are bottom views illustrating moving of first to third cameras, in accordance with one or more embodiments.

The driver 50 may provide a driving force to move the first camera 10. In an example, the driver 50 may include a motor 52 and a first gear 51.

The motor 52 may include a rotating shaft, and the rotating shaft of the motor 52 and the first gear 51 may be disposed to be connected to each other. In an example, the rotating shaft of the motor 52 and the first gear 51 may be configured to be engaged with each other by a gear structure.

The first camera 10 may include a second gear 15. The second gear 15 may be disposed to be connected to the first gear 51. For example, the first gear 51 and the second gear 15 may be configured to be engaged with each other by a gear structure.

Accordingly, driving force of the motor 52 may be transferred to the first camera 10 such that the first camera 10 may move in the first direction (for example, an upward or downward direction with reference to FIG. 6A).

Since the first camera 10 may be connected to the second camera 20 by the first link member 61, and the first camera 10 may be connected to the third camera 30 by the second link member 62, the second camera 20 and the third camera 30 may move while being interlocked with the first camera 10. In an example, when a movement of the first camera 10 is initiated, the first camera 10 and the second camera 20 may move independently from the third camera 30, or the first camera 10 and the third camera 30 may move independently from the second camera 20.

In other words, when the first camera 10 moves in the first direction (for example, the upward and downward direction), the second camera 20 and the third camera 30 may move in the second direction (for example, a left and right direction with reference to FIG. 6A) to be close to each other or to be spaced apart from each other.

FIGS. 6A and 7A illustrate an example in which the first to third cameras 10, 20, and 30 are disposed in a first position. The first position refers to a position in which centers of the first to third cameras 10, 20, and 30 are almost linearly disposed.

FIGS. 6C and 7C illustrate an example in which the first to third cameras 10, 20, and 30 are disposed in a second position. The second position refers to a position in which the first to third cameras 10, 20, and 30 are disposed in almost triangular form. For example, a line connecting centers of the first to third cameras 10, 20, and 30 may form an equilateral triangle.

In an example, a distance between the cameras in the second position may be the same. For example, a distance between the first camera 10 and the second camera 20, a distance between the first camera 10 and the third camera 30, and a distance between the second camera 20 and the third camera 30 may be the same.

FIGS. 6B and 7B illustrate an example in which the first to third cameras 10, 20, and 30 are disposed in a random position between the first position and the second position. In this example, a distance between the first camera 10 and the second camera 20, a distance between the first camera 10 and the third camera 30, and a distance between the second camera 20 and the third camera 30 may be different.

Referring again to FIG. 1, the cover 300 of the portable electronic device 1 may include an opening 310 that allows light to be incident to a lens of each camera. A cover glass 91 and a cover plate 92 may be disposed on a bottom surface of the opening 310.

The cover plate 92 may include an incident hole that corresponds to each camera. In an example, the cover plate 92 may include a first incident hole 92a corresponding to the first camera 10, a second incident hole 92b corresponding to the second camera 20, and a third incident hole 92c corresponding to the third camera 30.

The first incident hole 92a may be elongated in a moving direction (e.g., the first direction) of the first camera 10, and the second and third incident holes 92b and 92c may be elongated in a moving direction (the second direction) of the second camera 20 and the third camera 30.

The cover glass 91 may shield the opening 310 and the incident holes. Accordingly, external foreign objects, and the like, may be prevented from entering an internal space of the portable electronic device 1.

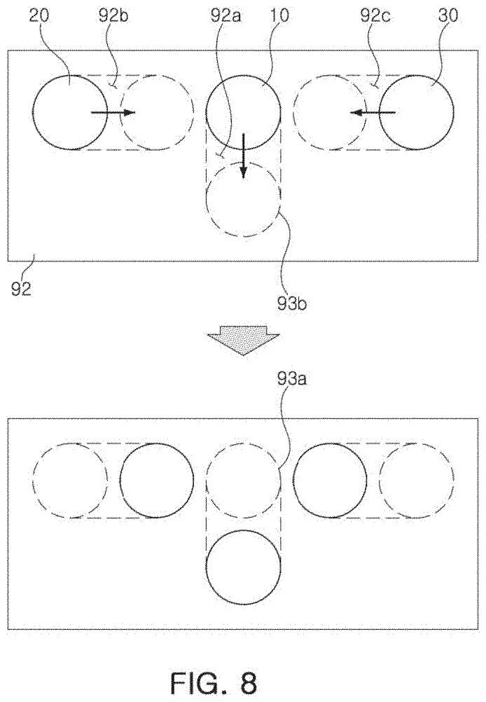

FIGS. 8 to 10 are views illustrating examples of various imaging methods of a camera module, in accordance with one or more embodiments.

In FIGS. 8 to 10, only a cover plate 92, the first camera 10, the second camera 20, and the third camera 30 are schematically illustrated for ease of description.

Referring to FIG. 8, an upper view in FIG. 8 illustrates an example in which the first to third cameras 10, 20, and 30 are disposed in the first position, and a lower view in FIG. 8 illustrates an example in which the first to third cameras 10, 20, and 30 are disposed in the second position.

The first to third cameras 10, 20, and 30 may also be disposed in any position between the first position and the second position according to an imaging method.

When the first to third cameras 10, 20, and 30 are disposed in the first position, a distance between the second camera 20 and the third camera 30 may be relatively great. Accordingly, a stereoscopic image may be obtained using the second camera 20 and the third camera 30.

In a non-limiting example, when implemented in the first position, the first camera 10 may be used for general imaging (e.g., an image with infrared rays blocked). Accordingly, an infrared cut filter 93a may be provided on one side of the first incident hole 92a.

In a non-limiting example, when the first to third cameras 10, 20, and 30 are disposed in the second position, a distance between the second camera 20 and the third camera 30 may be relatively short. Accordingly, general imaging may be performed using one of the second camera 20 and the third camera 30. Additionally, a high-quality image may be formed by synthesizing an image obtained by the second camera 20 and an image obtained by the third camera 30.

In a non-limiting example, in the second position, the first camera 10 may be used for infrared imaging (e.g., images that passed infrared rays). Accordingly, an infrared pass filter 93b may be provided on the second side of the first incident hole 92a.

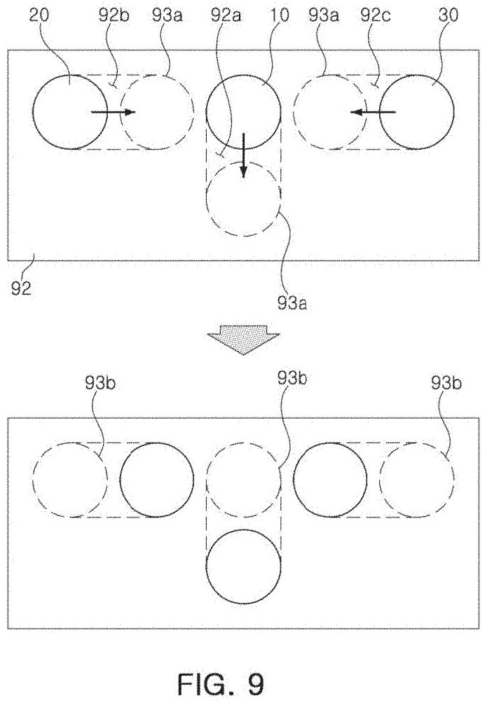

Referring to FIG. 9, the first to third cameras 10, 20, and 30 may be configured to have different fields of view. For example, the first camera 10 may have the widest field of view (wide angle), the second camera 20 may have the narrowest field of view (telephoto), and the third camera 30 may have an intermediate field of view (standard).

In a non-limiting example, in the first position, the first to third cameras 10, 20, and 30 may be used for infrared imaging. Accordingly, an infrared pass filter 93b may be provided on each of one side of the first incident hole 92a, one side of the second incident hole 92b, and one side of the third incident hole 92c.

In a non-limiting example, in the second position, the first to third cameras 10, 20, 30 may be disposed adjacent to each other. Accordingly, a zooming effect may be implemented using the first to third cameras 10, 20, and 30.

In this example, an infrared cut filter 93a may be provided on each of the second side of the first incident hole 92a, the second side of the second incident hole 92b, and the second side of the third incident hole 92c.

In an example, the first camera 10 may be used to image a subject in a wide range, the second camera 20 may be used to image a subject in a narrower range, and the third camera 30 may be used to image a subject in the narrowest range.

Accordingly, a zoom effect may be substantially implemented by conversion among the first to third cameras 10, 20, and 30 in a range from wide angle to telephoto.

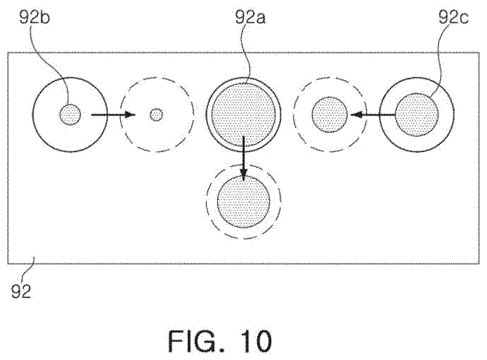

Referring to FIG. 10, incident holes having different sizes may be provided in the cover plate 92 depending on different positions of the cameras.

Diameters of one side and the other of each of the first to third incident holes 92a, 92b, and 92c may be configured to be different.

In an example, a diameter of the first incident hole 92a corresponding to the second position may be smaller than a diameter of the first incident hole 92a corresponding to the first position.

Additionally, a diameter of the second incident hole 92b corresponding to the second position may be smaller than a diameter of the second incident hole 92b corresponding to the first position.

Additionally, a diameter of the third incident hole 92c corresponding to the second position may be smaller than a diameter of the third incident hole 92c corresponding to the first position.

Accordingly, the cameras may have different F numbers depending on positions thereof.

Although not illustrated in the views, each camera may be divided into a lens unit and an image sensor unit.

When the camera moves, only one of the lens unit and the image sensor unit may move, and the other lens unit or the image sensor unit may be disposed in the position in which the moving is completed such that the camera may have various fields of view depending on the different positions.

According to the aforementioned examples, the camera module and the portable electronic device may change positions of the plurality of cameras such that a subject may be imaged by various methods.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
a base plate; and
a plurality of cameras provided on the base plate,
wherein one of the plurality of cameras is configured to be moved by a driver, and
wherein the other cameras of the plurality of cameras are configured to move while being interlocked with the one of the plurality of cameras.

2. The camera module of claim 1, wherein a distance between the other cameras is configured to decrease or increase when the one of the cameras moves.

3. The camera module of claim 1, wherein a direction in which the one of the cameras moves is perpendicular to a direction in which other cameras move.

4. The camera module of claim 1,
wherein a plurality of guide holes having lengths in moving directions of the plurality of cameras, respectively, are provided in the base plate,
wherein each of the plurality of cameras include a protrusion disposed in a corresponding guide hole, and
wherein the plurality of cameras is configured to move along the plurality of guide holes.

5. The camera module of claim 1, wherein the one of the cameras is connected to the other cameras by a link member.

6. The camera module of claim 1,
wherein the driver comprises a motor and a first gear connected to the motor, and
wherein the one of the cameras comprises a second gear connected to the first gear.

7. The camera module of claim 1,
wherein the plurality of cameras include a first camera, a second camera, and a third camera,
wherein the first camera is disposed between the second camera and the third camera, and
wherein the second camera and the third camera are configured to move while being interlocked with the first camera.

8. The camera module of claim 7,
wherein the first camera and the second camera are connected to each other by a first link member, and
wherein the first camera and the third camera are connected to each other by a second link member.

9. The camera module of claim 7, wherein the first camera, the second camera, and the third camera are configured to move from a position in which centers of the first camera, the second camera, and the third camera are linearly disposed, to a position in which the centers of the first camera, the second camera, and the third camera form a triangular shape.

10. The camera module of claim 1, wherein the first camera, the second camera, and the third camera are configured to have different fields of view.

11. A portable electronic device, comprising:
a case and a cover coupled to each other, and configured to form an internal space; and
a camera module disposed in the internal space,
wherein the camera module comprises:
a base plate;
at least three cameras provided on the base plate;
a driver configured to move one of the at least three cameras in a first direction; and
a link member configured to connect the one of the cameras to each of the other cameras,
wherein the other cameras are configured to move in a second direction perpendicular to the first direction while being interlocked with the one of the cameras.

12. The portable electronic device of claim 11,
wherein the at least three cameras include a first camera, a second camera, and a third camera, and
wherein the second camera and the third camera are configured to move closer or farther from each other when the first camera is moved by the driver.

13. The portable electronic device of claim 12, further comprising a cover plate mounted on the cover, the cover plate comprising a first incident hole which has a length formed in the first direction, a second incident hole which has a length formed in the second direction, and a third incident hole which has a length formed in the second direction,
wherein an infrared cut filter is mounted on one of a first side and a second side of the first incident hole, and an infrared pass filter is mounted on the other of the first side and the second side of the first incident hole.

14. The portable electronic device of claim 12, further comprising a cover plate mounted on the cover, the cover plate comprising a first incident hole which has a length formed in the first direction, a second incident hole which has a length formed in the second direction, and a third incident hole which has a length formed in the second direction,
wherein diameters of a first side and a second side of each of the first incident hole, the second incident hole, and the third incident hole are configured to be different from each other.

15. A portable electronic device comprising:
a case and a cover coupled to each other, and configured to form an internal space; and
a camera module disposed in the internal space;
wherein the camera module comprises:
a base plate;
a plurality of cameras provided on the base plate;
a driver configured to selectively move the plurality of cameras in different respective directions; and
a link member configured to connect the plurality of cameras based on a selection of the driver;
wherein the plurality of cameras include:
a first camera, configured to move in a first direction;
a second camera, configured to move in a second direction, perpendicular to the first direction; and
a third camera, configured to move in a third direction, perpendicular to the first direction,
wherein the second camera and the third camera are configured to move while being interlocked with the first camera.

16. The device of claim 15, wherein the first camera, the second camera, and the third camera are configured to have different fields of view.

17. The device of claim 15, wherein a linear distance between the second camera and the third camera increases or decreases based on a movement of the first camera.

18. The device of claim 15, wherein the first camera is connected to the second camera by a first link, and the first camera is connected to the third camera by a second link.
